(19) United States
(12) Patent Application Publication
(10) Pub. No.: US 2006/0136160 A1
(43) Pub. Date: Jun. 22, 2006

(54) System and method for generating reports of coordinate measuring machine

(75) Inventors: Guang-Yong Gao, Shenzhen (CN); Tao Zhang, Shenzhen (CN); Chen-Ming Lee, Tu-Cheng (TW); Wee-Peng Tay, Singapore (SG)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO.,LTD, Shindian City (TW)

(21) Appl. No.: 11/311,980

(22) Filed: Dec. 19, 2005

(30) Foreign Application Priority Data
Dec. 21, 2004 (TW) 93139743

(51) Int. Cl. G01P 21/00

(52) U.S. Cl. 702/95

(57) ABSTRACT

A system for generating reports of coordinate measuring machine includes: a coordinate measuring machine (10), a system control box (11), a computer (12), a typewriter (13), and a database (14). The computer includes: a system interface module (121) providing an operating system of the coordinate measuring machine; a data processing module (122) for processing measured data; and a report generating module (123) for generating reports of coordinate measuring machine. A method of generating reports of coordinate measuring machine is also provided.

### BACKGROUND OF THE INVENTION

1. Field of the Invention

The present invention is generally related to a system and method for generating reports of Coordinate Measuring Machine.

2. General Background

Coordinate Measuring Machine (CMM) has been used for industrial quality control to inspect the products of computer numerical control machine tools and to check feature locations of parts after machining. Although the CMM was once considered an exotic tool found only in large manufacturing plants, the increased need for accurate measurement of components has become an important concern for small job shops as well. Accordingly, modem CMM is significantly smaller and more affordable, and is becoming commonplace in the average machine shop. CMM has the advantages of rapidity, accuracy and good repetitiveness, and has been widely used in production measurement. However, because data processing of a CMM may be greatly different from actual demands, much manual work must be involved when users handle the CMM. The operating system of CMM also has many disadvantages in data processing. For example, data conversion procedures of a CMM are always complicated and inefficient. Thus, users make mistakes easily when operating the CMM, and usually have to take much time to edit programs and process corresponding data.

Therefore, what is needed is a system and method applied in a CMM, which can complete data processing and data conversion easily according to different user demands.

### SUMMARY

One embodiment of the present invention provides a system for generating reports of Coordinate Measuring Machine (CMM). The system typically includes a CMM, a system control box connected to the CMM, and a computer connected to the system control box. The computer includes: a system interface module providing an interface for an operating system of the CMM; a data processing module used for processing measured data from the CMM; and a report generating module used for generating CMM reports.

The data processing module typically includes a data reading/saving sub-module and a data checking sub-module. The data reading/saving sub-module is used for obtaining measured data from the CMM, determining types of the measured data, selecting a calculation method for each data type. The data checking sub-module is used for checking the measured data, and sending error information to users when there are abnormal measured data.

The data checking sub-module further includes an abnormal dimension list, which includes a number of each abnormal measured dimension, and a maximum value and a minimum value corresponding to the measured dimension.

Another embodiment of the present invention provides a method for generating CMM reports by utilizing the above described system. When the system starts, the system interface module sets up a connection with an operating system of the CMM. The data reading/saving sub-module reads measured data of a sample from the CMM, and determines types of the measured data. The measured data may include ordinary dimension data and position dimension data, wherein the ordinary dimension data can be read directly, and the position dimension data are read according to actual needs. Then, the data reading/saving sub-module selects a calculation method for each data type. The data reading/saving sub-module saves the measured data in a database. The data checking sub-module checks whether all samples have been measured. If any sample has not been measured by the CMM, the procedure returns to read measured data from the CMM. Otherwise, if all samples have been measured, the data checking sub-module checks whether the number of dimensions included in measured data of each sample is correct, and checks a total distance for each dimension. The report generating module obtains the measured data from the database, and generates corresponding CMM reports.

Other advantages and novel features of the present invention will be drawn from the following detailed description of a preferred embodiment and preferred method with the attached drawings, in which:

### BRIEF DESCRIPTION OF THE DRAWINGS

FIG. 1 is a schematic diagram of hardware configuration of a system for generating reports of Coordinate Measuring Machine, in accordance with one embodiment of the present invention;

FIG. 2 is a schematic diagram of software function modules of a computer of the system of FIG. 1;

FIG. 3 is flowchart of a preferred method for generating reports of Coordinate Measuring Machine, in accordance with one embodiment of the present invention; and

FIG. 4 is a flowchart illustrating in detail one step of FIG. 3, namely, checking measured data.

### DETAILED DESCRIPTION OF THE PREFERRED EMBODIMENTS

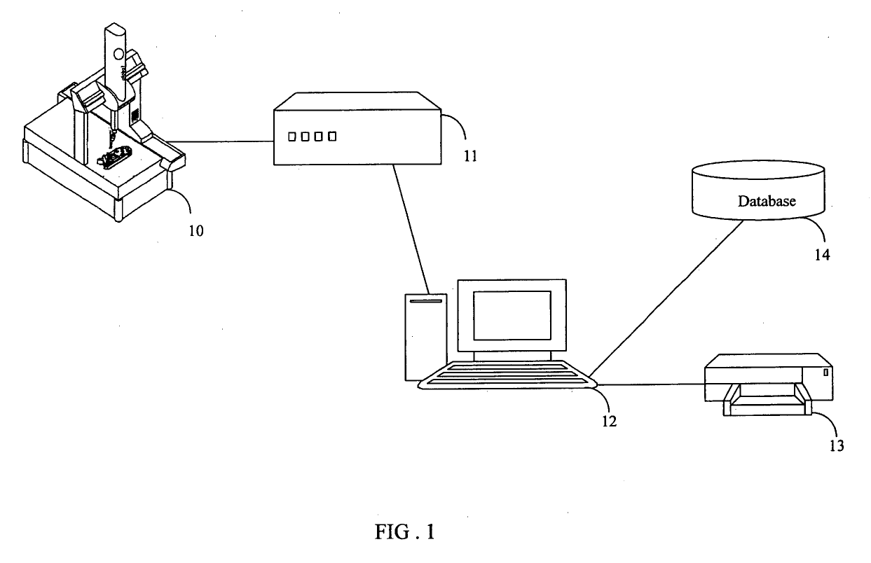

FIG. 1 is a schematic diagram of hardware configuration of a system for generating reports of Coordinate Measuring Machine (hereinafter, “the system”) in accordance with one embodiment of the present invention. The system typically includes a CMM (Coordinate Measuring Machine) 10, a system control box 11, a computer 12, a printer 13 and a database 14. The CMM 10 is provided for measuring various samples. The system control box 11 is connected with the CMM 10, for controlling operations of the CMM 10 and converting instructions and data sent to or received from the CMM 10. The computer 12 is connected with the system control box 11, and may be a desktop computer, a laptop computer, a notebook or any other suitable type of computing device. The computer 12 stores an operating system of the CMM 10, and provides an operating interface for displaying operating status dynamically. The computer 12 has a plurality of software modules installed therein, for performing various functions of the system. The database 14 is connected with the computer 12, for storing data or files generated during the measuring process. The printer 13 is also connected with the computer 12, and can be used for printing CMM reports when necessary.

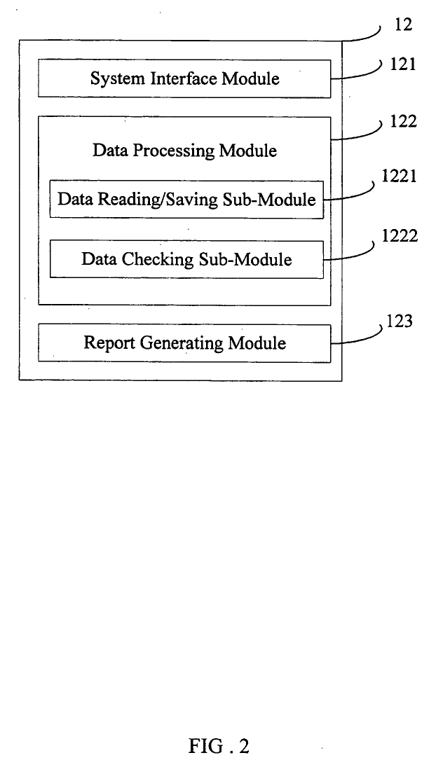

FIG. 2 is a schematic diagram of software function modules of the computer 12. The computer 12 mainly includes a system interface module 121, a data processing module 122, and a report generating module 123. The data processing module 122 further includes a data reading/saving sub-module 1221 and a data checking sub-module 1222.

The system interface module 121 provides an interface for the operating system of the CMM 10, which can be used for obtaining relevant data of current measuring programs for generating CMM reports.

The data processing module 122 can be used for processing measured data in real time, and includes a data reading/saving sub-module 1221 and a data checking sub-module 1222. The data reading/saving sub-module 1221 is used for obtaining measured data from the CMM 10, determining types of the measured data, selecting a calculation method for each data type, and storing the measured data in the database 14. Generally, the measured data may include ordinary dimension data that can be read or retrieved directly from original output measure results of the CMM 10 based on particular keywords therein, and position dimension data that are read according to actual needs. The data checking sub-module 1222 is used for checking the measured data, and sending error information to users when there are abnormal measured data. The data checking includes: checking whether the number of dimensions included in measured data of each sample is correct, and checking a total distance for each dimension. Checking the total distance of a dimension typically includes the steps of: finding a maximum value and a minimum value of the dimension; subtracting the minimum value from the maximum value and getting a deviation value; comparing the deviation value with a predetermined maximum deviation value; putting the dimension in an abnormal dimension list if the deviation value is greater than the predetermined maximum deviation value. The abnormal dimension list not only includes a number of each abnormal measured dimension, but also includes a maximum value and a minimum value corresponding to the measured dimension.

The report generating module 123 is used for generating CMM reports according to corresponding measured data from the database 14. The report generating module 123 can output the CMM reports to the printer 13 in Excel format or any other suitable format which is customized by users.

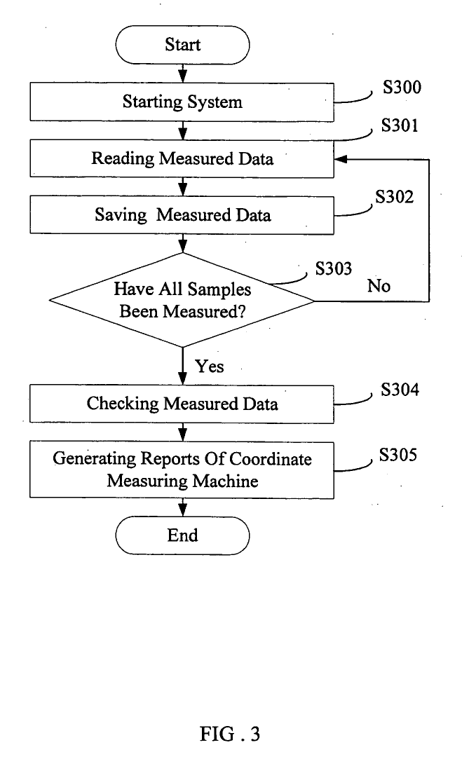

FIG. 3 is flowchart of a preferred method for generating CMM reports by utilizing the system of FIG. 1. In step S300, when the system starts, the system interface module 121 sets up a connection with an operating system of the CMM 10. In step S301, the data reading/saving sub-module 1221 reads measured data of a sample from the CMM 10, and determines types of the measured data. The measured data may include position dimension data and ordinary dimension data, wherein the ordinary dimension data can be read directly, and the position dimension data are read according to actual needs. Then, the data reading/saving sub-module 1221 selects a calculation method for each data type. In step S302, the data reading/saving sub-module 1221 saves the measured data in the database 14. In step S303, the data checking sub-module 1222 checks whether all samples have been measured. If any sample has not been measured by the CMM 10, the procedure returns to the step S301 described above. Otherwise, if all the samples have been measured, in step S304, the data checking sub-module 1222 checks whether the number of dimensions included in measured data of each sample is correct, and checks a total distance for each dimension. In step S305, the report generating module 123 obtains the measured data from the database 14, and generates corresponding CMM reports.

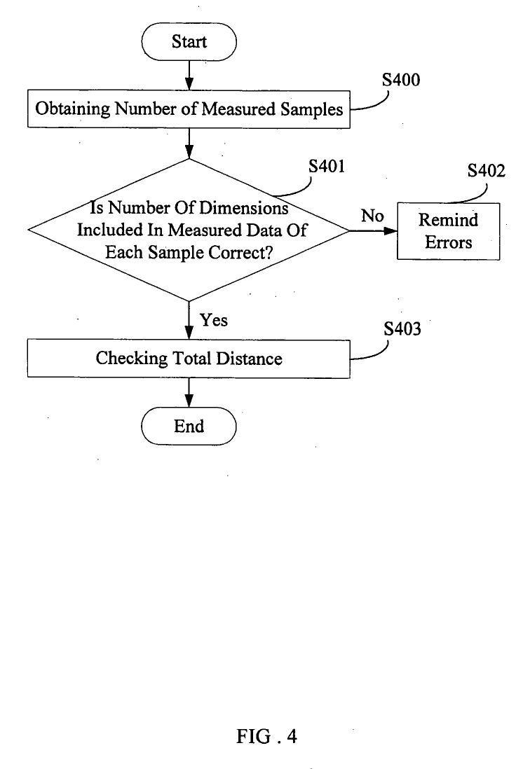

FIG. 4 is a flowchart illustrating step S304 in detail. In step S400, the data reading/saving sub-module 1221 obtains the number of measured samples. In step S401, the data checking sub-module 1222 checks whether the number of dimensions included in measured data of each sample is correct. If the number of dimensions included in measured data of any sample is not correct, in step S402, the data checking sub-module 1222 sends error information to users. Otherwise, if the number of dimensions included in measured data of each sample is correct, in step S403, the data checking sub-module 1222 checks a total distance for each dimension according to the following steps: finding a maximum value and a minimum value of a dimension; subtracting the minimum value from the maximum value and getting a deviation value; comparing the deviation value with a predetermined maximum deviation value; and putting the dimension in an abnormal dimension list if the deviation value is greater than the predetermined maximum deviation value.

Although the present invention has been specifically described on the basis of a preferred embodiment and a preferred method, the invention is not to be construed as being limited thereto. Various changes and modifications may be made to the embodiment and method without departing from the scope and spirit of the invention.

We claim:

1. A system for generating reports of coordinate measuring machine, the system comprising a coordinate measuring machine, a system control box connected to the coordinate measuring machine, and a computer connected to the system control box, the computer comprising:
a system interface module providing an operating system of the coordinate measuring machine;
a data processing module for processing measured data from the coordinate measuring machine; and
a report generating module for generating reports of coordinate measuring machine.

2. The system according to claim 1, wherein the data processing module comprises:
a data reading/saving sub-module for reading the measured data from the coordinate measuring machine, determining types of the measured data, and for selecting a calculation method for each data type; and
a data checking sub-module for checking the measured data.

3. The system according to claim 2, wherein the data checking sub-module comprises an abnormal dimension list, which includes a number of each abnormal measured dimension, and a maximum value and a minimum value corresponding to the measured dimension.

4. A method for generating reports of coordinate measuring machine, the method comprising the steps of:
starting a system for generating reports of coordinate measuring machine, the system comprising a coordinate measuring machine, a system control box connected to the coordinate measuring machine, and a computer connected to the system control box;
reading measured data of samples from the coordinate measuring machine, determining types of the measured data, and selecting a calculation method for each data type;
saving the measured data in a database;
checking whether all samples have been measured;
checking whether the number of dimensions included in measured data of each sample is correct if all the samples have been measured;
checking a total distance for each dimension; and
generating corresponding reports of coordinate measuring machine.

5. The method according to claim 4, wherein the step of checking whether all samples have been measured further comprises the step of:
returning to the step of reading measured data of samples from the coordinate measuring machine if any sample has not been measured.

6. The method according to claim 4, wherein the step of checking whether the number of dimensions included in measured data of each sample is correct further comprises the step of:
sending error information to users if the number of dimensions included in measured data of any sample is not correct.

7. A method for generating customized reports of measure results of a coordinate measuring machine, comprising the steps of:
initializing a coordinate measuring machine to generate original measure results;
retrieving user-required measured data from said original measure results by means of locating said data in said original results;
verifying correctness of said retrieved measured data; and
generating reports based on user-customized formats.

8. The method according to claim 7, wherein said verifying step further comprises the steps of checking correctness of the number of dimensions included in said measured data, and checking a total distance for each of said dimensions.
